(19) United States
(12) Patent Application Publication
(10) Pub. No.: US 2015/0139428 A1
(43) Pub. Date: May 21, 2015

(54) APPARATUS WITH A SPEAKER USED AS SECOND MICROPHONE

(71) Applicant: Knowles IPC (M) Snd. Bhd., Penang (MY)

(72) Inventors: Friedrich Reining, Vienna (AT); Claus Erdmann Furst, Roskilde (DK)

(21) Appl. No.: 14/547,377

(22) Filed: Nov. 19, 2014

Related U.S. Application Data
(60) Provisional application No. 61/896,417, filed on Nov. 20, 2013.

(51) Int. Cl. G10L 21/02; H04R 3/00

(52) U.S. Cl. CPC G10L 21/02; H04R 3/007; H04R 3/00
USPC 381/55

(57) ABSTRACT

An apparatus comprising at least a first microphone with a first acoustic sensitivity to provide a first microphone signal and a second microphone with a lower second acoustic sensitivity to provide a second microphone signal, that apparatus furthermore comprises a signal processor that is built to process the first microphone signal to be recorded and/or transmitted and an overload detector to detect an overload of the first microphone signal and wherein the signal processor in case of a detected overload is built to process the second microphone signal to substitute the first microphone signal to be recorded and/or transmitted during the time period in which the overload of the first microphone signal is detected, which apparatus furthermore comprises at least a first speaker built to receive a first speaker signal and transform it into acoustic sound, in a speaker mode of the first speaker, while the apparatus is built to use the first speaker as second microphone, in a microphone mode of the first speaker.

### FIELD OF THE INVENTION

The present invention generally relates to an apparatus comprising at least a first microphone with a first acoustic sensitivity to provide a first microphone signal and a second microphone with a lower second acoustic sensitivity to provide a second microphone signal.

### BACKGROUND OF THE INVENTION

Document WO 2010/039437 A1 discloses such an apparatus in an embodiment of a mobile phone. The mobile comprises four microphones that provide four different microphone signals. To improve the quality of the voice signal of a user that speaks into the mobile, it comprises a microphone selection algorithm that dynamically selects the microphone signal for further processing that provides the voice dominant signal with the best quality. Microphone signals of other not selected microphones are used to capture and identify background noise. A signal processor uses the information about the actual background noise to enhance the signal to noise ration to improve the quality of the voice signal captured with the selected microphone.

The mobile phone furthermore comprises an accelerometer to give an indication about the position and movement of the mobile. The signal processor uses this information of the accelerometer to improve the decision which of the microphone signals of the four microphones to use. The mobile phone furthermore comprises a loudspeaker, an earpiece speaker and a headset to transform a speaker signal into acoustic sound.

Tests with mobile phones like the one described in WO 2010/039437 A1 have revealed, that the quality of the voice signal provided by the signal processor is still poor in some particular use cases like in windy environments or with users that speak plosive utterances in a special the microphone overloading way. Furthermore the algorithm to continuously detect which of the four microphone signals comprises the best voice dominant signal is complex and needs a huge amount of processing power while it only provides poor results.

### SUMMARY OF THE INVENTION

It is an object of the invention to provide an apparatus like e.g. a mobile phone that provides an improved microphone signal to be recorded and/or transferred in use cases like in windy environments or with users that speak plosive utterances with a better quality without the need to add further microphones to the apparatus. This object is achieved with an apparatus that furthermore comprises a signal processor that is built to process the first microphone signal to be recorded and/or transmitted and an overload detector to detect an overload of the first microphone signal and wherein the signal processor in case of a detected overload is built to process the second microphone signal to substitute the first microphone signal to be recorded and/or transmitted during the time period in which the overload of the first microphone signal is detected, which apparatus furthermore comprises at least a first speaker built to receive a speaker signal and transform it into acoustic sound, in a speaker mode of the first speaker, while the apparatus is built to use the first speaker as second microphone, in a microphone mode of the first speaker.

The speaker of an apparatus like a mobile phone or a dictation machine can be used as a microphone with a low acoustic sensitivity. In modes of an apparatus like a dictation machine where acoustic sound needs to be captured and recorded with the dictation machine, but the speaker is not used in its speaker mode, the speaker can be used as microphone that provides an additional microphone signal. As mobiles these days comprise more than one speaker while most of the times only one speaker is active dependent on the speaker mode selected by the user, the other one or two speaker available in the mobile may be used in their microphone mode to provide additional second microphone signals to switch to in cases of an overload of the first microphone signal.

These and other aspects of the invention will be apparent from and elucidated with reference to the embodiments described hereinafter. The person skilled in the art will understand that various embodiments may be combined.

### BRIEF DESCRIPTION OF THE DRAWINGS

FIG. 1 shows part of a mobile phone that comprises a microphone and two speakers that are used as low sensitivity microphones according to a first embodiment of the invention.

FIG. 2 shows part of a mobile phone that comprises a speaker used as low sensitivity microphone according to a second embodiment of the invention.

FIG. 3 shows part of a mobile phone that comprises a speaker used as low sensitivity microphone according to a third embodiment of the invention.

FIG. 4 shows the simulation result of the acoustic sensitivity of a speaker used in its microphone mode.

FIG. 5 shows the simulation result of the acoustic sensitivity of a speaker for different sound channels.

FIG. 6 shows the simulation result of the acoustic sensitivity of a speaker for a fixed sound channel, but different shunt resistors.

### DETAILED DESCRIPTION OF EMBODIMENTS

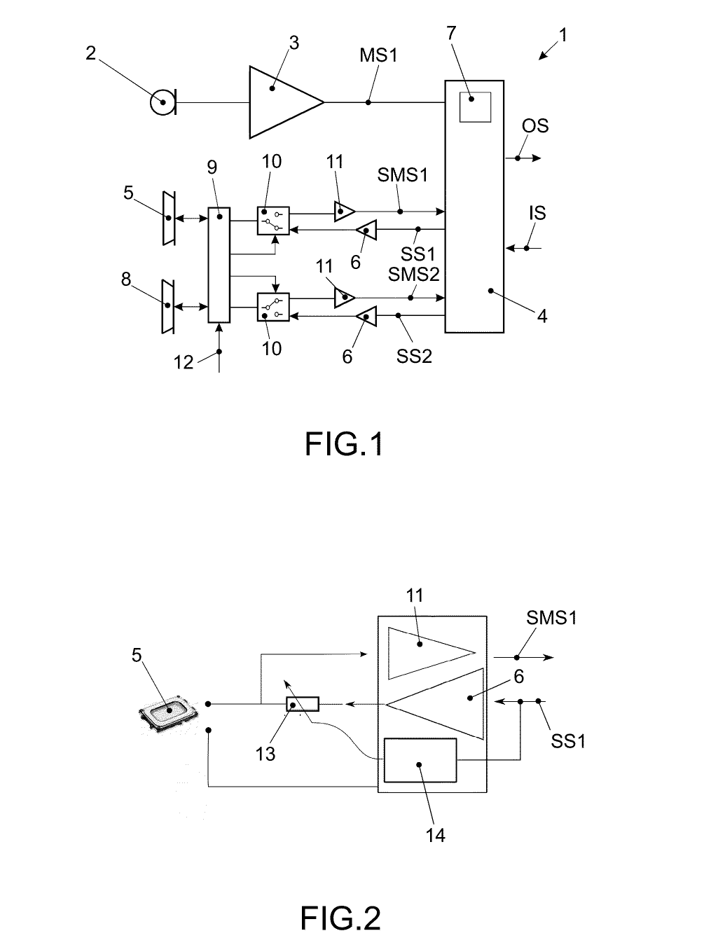

FIG. 1 shows part of a mobile phone 1 that comprises a first microphone 2 to provide a first microphone signal MS1 and a microphone input amplifier 3 to amplify the first microphone signal MS1. The mobile phone 1 furthermore comprises a signal processor 4, that is built to process the first microphone signal MS1 to improve the signal to noise ratio and to provide the first microphone signal MS1 as output signal OS in a format for further processing of the first microphone signal MS1. The output signal OS may be recorded on a storage medium in or outside of the mobile phone 1 or may be transmitted by the mobile phone 1 over the telephone network to another mobile phone.

The mobile phone 1 furthermore comprises a first speaker 5 to be held close to the ear of the user to hear acoustic sound of a first speaker signal SS1 received as an input signal IS from a storage medium of the mobile phone 1 or over the telephone network from another mobile phone. The signal processor 4 processes the input signal IS and provides the first speaker signal SS1 via a speaker output amplifier 6 to the first speaker 5.

The mobile phone 1 furthermore comprises an overload detector 7 to detect an overload of the first microphone signal MS1. An overload is detected in case the signal level of the first microphone signal MS1 is above an overload signal level, which for instance could be 120 dB SPL (sound pressure level related to a threshold of hearing of 20 μPa). In this case the first microphone 2 overrides and the first microphone signal MS1 captured by the first microphone 2 will not provide a useful microphone signal.

In case the overload detector 7 detects an overload of the first microphone signal MS1, the signal processor 4 is built to process a second microphone signal to substitute the first microphone signal MS1 to be recorded and/or transmitted during the time period in which the overload of the first microphone signal MS1 is detected. To avoid further costs of the mobile phone 1 for a separate second microphone, the mobile phone 1 is built to use the first speaker 5 as second microphone, in a microphone mode of the first speaker 5. This is possible in use cases, where the first speaker 5 is not used as speaker in its speaker mode to provide acoustic sound for the user. In the microphone mode, the first speaker 5 provides a first speaker microphone signal SMS1 for further processing by the signal processor 4.

The mobile phone 1 comprises a second speaker 8 used in a hands-free speaker phone mode to provide acoustic sound to one or more users of the mobile phone 1. In case the hands-free speaker phone mode is selected by the user, the second speaker 8 will be used in its speaker mode and provides acoustic sound of a second speaker signal SS2 received in the input signal IS from a storage medium of the mobile phone 1 or over the telephone network from another mobile phone. In case the hands-free speaker mode is not selected by the user, then the second speaker 8 will not be used in its speaker mode and therefore can be used in its microphone mode as second microphone to provide a second speaker microphone signal SMS2. The mobile phone 1 comprises a control circuit 9 that switches to use either the first speaker 5 or the second speaker 8 in the speaker mode while the other of the first and second speaker 5 or 8 is used as second microphone in the microphone mode of the speaker.

The mobile phone 1 furthermore comprises speaker switches 10 to connect the speaker contact of the first speaker 5 and the second speaker 8 in their speaker mode with the speaker output amplifier 6 and in their microphone mode with a microphone input amplifier 11. The microphone input amplifier 11 is built to amplify the speaker microphone signals SMS1 and SMS2 provided by the first speaker 5 or the second speaker 8 in their microphone mode. The signal processor 4 is built to process the first speaker microphone signal SMS1 and the second speaker microphone signal SMS2 in such a way to record and or transmit it in time periods the overload detector 7 detected an overload of the first microphone signal MS1 to substitute the first microphone signal MS1 with the second microphone signal.

This provides the advantage that in time periods that could last for only a few milliseconds or even several minutes, in which time periods the first microphone signal MS1 only provides bad quality acoustic information, the first microphone signal MS1 is substituted by the second microphone signal MS2 in the output signal OS. As the second microphones 5 or 8 comprise a lower acoustic sensitivity as the first microphone 2, the second microphone 5 or 8 will not override and the quality of the acoustic information in the output signal OS is improved.

Tests have shown that in case of windy environments, where the speech or sound to be captured is overlaid by a wind noise, and in case the user of the mobile phone 1 speaks plosive utterances in a special the microphone overloading way, the first microphone is overloaded for short or longer time periods. The signal processor 4 is built to dynamically switch between the first microphone 1 and the first speaker 5 or second speaker 8, the one which is in its microphone mode, to select which microphone signal is used for further processing. This enables a continuous high quality of the sound information in the output signal OS.

In another embodiment the overload detector 7 is built to detect, if the signal level of the first microphone signal MS1 in a particular frequency range is above a frequency range specific overload signal level. The impact of wind noise for instance is not only loud in very low frequency areas of e.g. 1 Hz to 100 Hz, but may deflect the microphone diaphragm to a different operating point resulting in a microphone speech recording performance degrading manner. These operating point affecting low frequencies are most commonly filtered out by a high pass filter in order to prevent an overload of the microphone signal whereas the degradation of signal components found in other frequency ranges (e.g. speech) is still present. The overload condition for very low frequencies measured at the first microphone signal MS1 therefore needs a significantly lower signal level or amplitude. The overload condition is not restricted to a fixed signal level or a list of frequency dependent signal levels, but may be extended to a time-frequency analysis of the first microphone signal by means of the signal processing unit 4.

In another embodiment a frequency range of e.g. 10 kHz to 11 kHz could be used to detect overload of the first microphone 2, if e.g. a machine close to the apparatus or mobile phone makes noise in this frequency range. For this particular situation the signal processing unit 4 can be programmed in a way to mix the first microphone signal MS1 suppressing the frequency range between 10 and 11 kHz with the band passed second microphone signal SMS2.

For the speaker output amplifier, it has been proven to be advantageous to use a class D amplifier for the reasons of cost, performance and efficiency.

The control circuit 9 is connected via a connection 12 to the main controller of the mobile phone 1, to switch to use either the first speaker 5 or the second speaker 8 in the speaker mode while the other of the first and second speaker 5 or 8 is used as second microphone in the microphone mode of the speaker. This main controller controls the modes of the mobile phone 1 selected by the user and provides the information to the control circuit 9 whether or not the hands-free speaker mode is selected. In another advantageous embodiment, explained in more detail with reference to FIG. 2, there is no such connection 12 between the control circuit 9 and the main controller, but the control circuit 9 detects whether the signal processor 4 provides either the first speaker signal SS1 for the first speaker 5 or the second speaker signal SS2 for the second speaker 8. This speaker that receives the speaker signal is in its speaker mode and the other of the two speakers therefore is in its microphone mode and used as second microphone. This automatic detection reduces the hardware costs and complexity of the mobile phone.

The signal processor 4 processes an algorithm to enable the substitution of the first microphone signal MS1 with the first speaker microphone signal SMS1 or the second speaker microphone signal SMS2 as second microphone signal with minimal distortion. This includes a switching algorithm that first adapts the signal levels of microphone signal SMS1 or SMS2 to the first microphone signal SMS1 and secondly minimizes the phase differences between these signals. Switching at the moment of zero crossing leads to an optimal result by means of non-audibility of switching noise. In an even preferred embodiment the signal processor 4 is built to cross fade while switching between the first and second microphone signal. This in addition reduces any distortion while switching.

FIG. 2 discloses the first speaker 5 and the elements to connect it with the signal processor 4 according to a further embodiment of the invention. In this embodiment the speaker switch 10 is replaced by a shunt resistor 13 and a control circuit 14, which adjusts the ohmic resistance of the shunt resistor 13. The control circuit 14 detects, if there is a first speaker signal SS1 from the signal processor 4 and reduces the resistance of the shunt resistor 13 to more or less zero Ohm to ensure the full sound level of the first speaker 5 in its speaker mode. If the control circuit 14 detects that there is no first speaker signal SS1 from the signal processor 4, then the control circuit 14 increases the resistance of the shunt resistor 13 in the range of the speaker impedance to ensure that the first speaker microphone signal SMS1 is not short circuited by the speaker output amplifier 6 and gets into the microphone input amplifier 11.

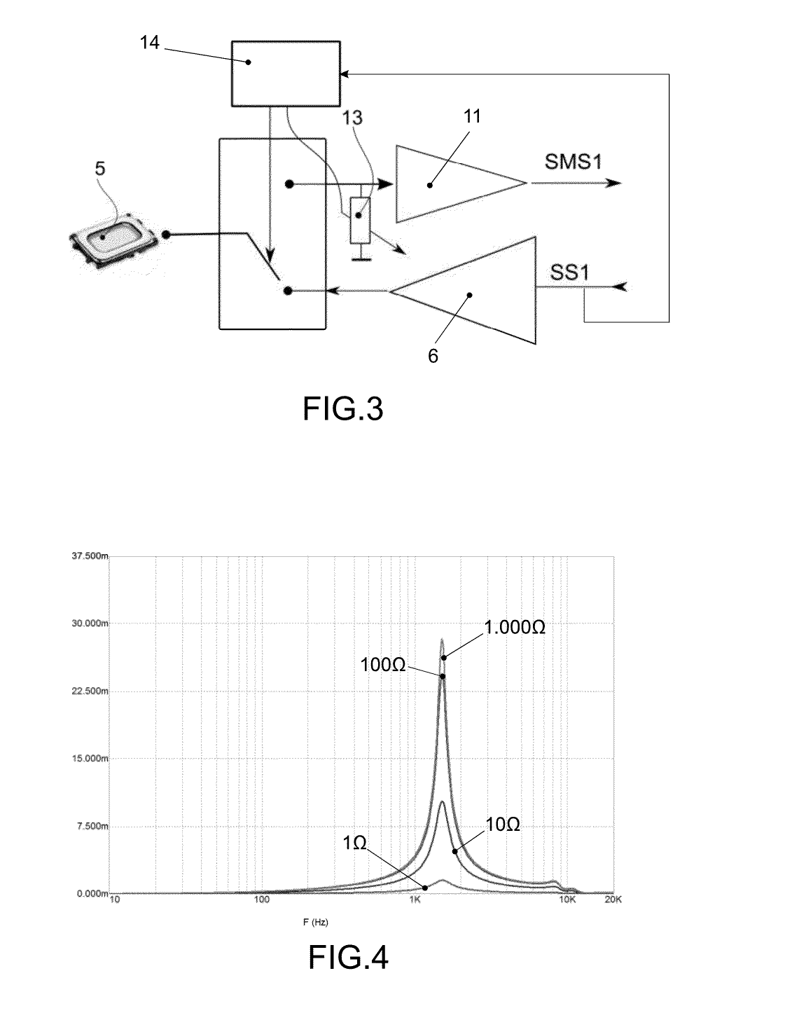

FIG. 3 discloses the first speaker 5 and the elements to connect it with the signal processor 4 according to a further embodiment of the invention. In this embodiment the speaker switch 10 is amended by a shunt resistor 13 and a control circuit 14, which adjusts the ohmic resistance of the shunt resistor 13. The control circuit 14 detects, if there is a first speaker signal SS1 from the signal processor 4 and switches to the first speaker 5 in its speaker mode. If the control circuit 14 detects that there is no first speaker signal SS1 from the signal processor 4, then the control circuit 14 switches to the microphone input amplifier 11 and adjusts the resistance of the shunt resistor 13 in order to adjust the frequency response as can be seen from FIG. 4.

As a microphone is based on an electrostatic microphone principle and a speaker is based on an electrodynamic speaker principle the microphone signal of a speaker used in its microphone mode needs some additional signal processing. A dynamic microphone is optimized by means of acoustic sensitivity and frequency response. FIGS. 4 to 6 disclose simulations that are based on very loud sound pressure levels (120 dB) to support the real microphone in specific use cases.

FIG. 4 shows a simulation of microphone acoustic sensitivity [V] versus frequency [Hz] where the second speaker 8 mounted in a closed box is used in its microphone mode. In normal telephone operation (not hands-free mode) sound propagates to the membrane of the second speaker 8, which is not used in its speaker mode. A rectangular speaker (13×18×4.5 mm) in a closed box with a 1 ccm back volume was used. The different curves represent the input impedance of the amplifier (1Ω, 10Ω, 100Ω and 1,000Ω), when the speaker is exposed to a sound pressure level of 120 dB. Note the dependency of quality factor and input impedance.

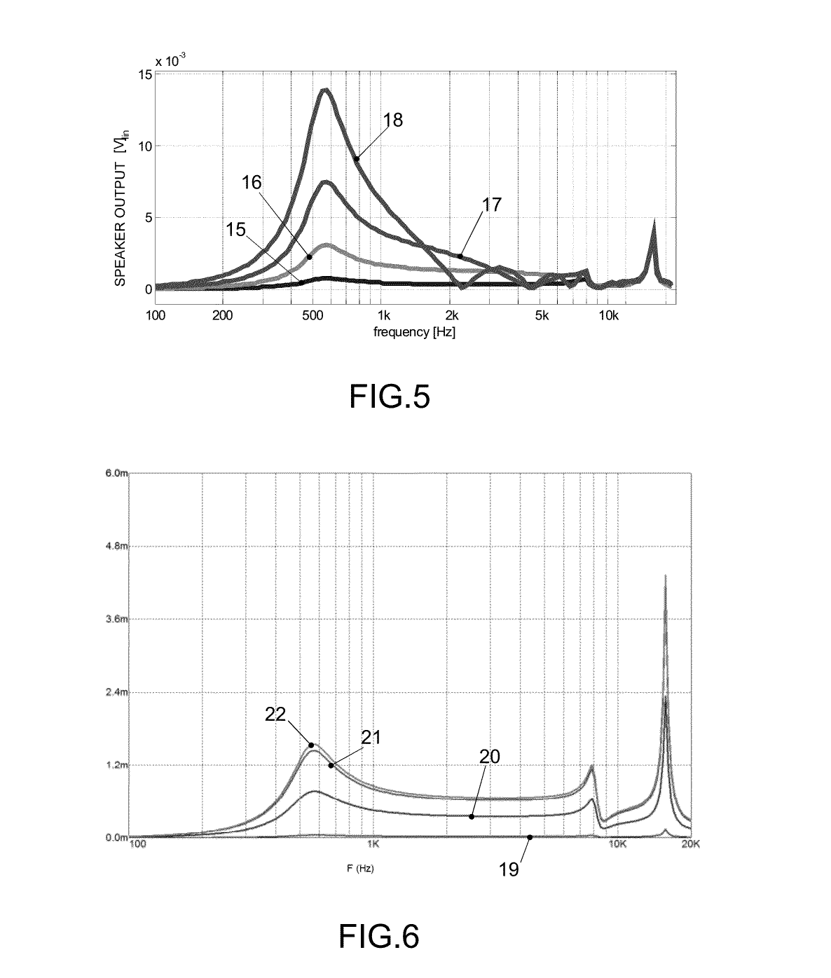

FIG. 5 shows a simulation, where the first speaker 5 in hands-free mode acts as second microphone. Since the first speaker 5 should be held close to the ear of the user, it is usually not built in a speaker box. This setup needs to be modelled differently for sound is approaching the first speaker from the front and the rear side. Path to the open backside of the first speaker 5 results in different frequency responses. Modeled are two paths with ˜5 mm (curve 15) port distance (front-back), 2 cm (curve 16) and 5 cm (curve 17) up to 10 cm (curve 18). All simulations are done with a input impedance of 1 kΩ.

FIG. 6 shows a simulation of microphone acoustic sensitivity [V] versus frequency [Hz] with the set-up of FIG. 5, but where the path is kept constant at lcm length. The acoustic sensitivity of the first speaker 5 in its microphone mode drops significantly, when the input impedance of the amplifier is set to 1Ω (curve 19), 32Ω (curve 20), 320Ω (curve 21), 1,000Ω (curve 22).

Based on these simulation results a high impedance of the microphone input amplifier 11 improves the quality of the second microphone signal. It is therefore advantageous to increase the ohmic resistance of the shunt resistor 13 above the value of a typical speaker impedance (e.g. 500Ω, 1 kΩ or even more).

In another embodiment the apparatus is a dictation machine to capture and record acoustic sound with the dictation machine. During record mode the speaker is not used in its speaker mode and therefore the speaker can be used as second microphone that provides an additional microphone signal. A man skilled in the art will understand that there are several other apparatuses that could make use of this invention in the same way.

In another embodiment the apparatus comprises three or more speaker on different parts of its casing. The apparatus will select that speaker to be used in its microphone mode to provide the second microphone signal that is closest to the sound to be recorded or transmitted.

What is claimed is:

1. An apparatus comprising:
a first microphone for providing a first microphone signal, the first microphone having a first acoustic sensitivity;
a second microphone for providing a second microphone signal, the second microphone having second acoustic sensitivity lower than the first acoustic sensitivity of the first microphone;
a signal processor configured to process the first microphone signal to be recorded and/or transmitted; and
an overload detector configured to detect an overload of the first microphone signal, wherein, the signal processor is configured to process the second microphone signal and, when an overload of the first microphone signal is detected, to substitute the second microphone signal for the first microphone signal to be recorded and/or transmitted during the time period in which the overload of the first microphone signal is detected.

2. The apparatus of claim 1, further comprising a first speaker, the first speaker configured to receive a first speaker signal and transform it into acoustic sound while in a speaker mode, and configured to operate as the second microphone while in a microphone mode.

3. The apparatus according to claim 1, which comprises at least a second speaker and a control circuit that switches to use either the first speaker or the second speaker in the speaker mode while the other of the first speaker and second speaker is used as second microphone in the microphone mode of the speaker.

4. The apparatus according to claim 2, wherein the overload detector detects the overload of the first microphone signal in case the signal level is above an overload signal level or if the signal level of the first microphone signal in a particular frequency range is above a frequency range specific overload signal level.

5. The apparatus according to claim 2, which comprises a speaker output amplifier, preferred a class D amplifier, to amplify the speaker signal provided to the first speaker or the second speaker in their speaker mode and that comprises a microphone input amplifier to amplify the speaker microphone signal provided by the first speaker or the second speaker in their microphone mode and that comprises
a speaker switch to connect the speaker contact of the first speaker and the second speaker in their speaker mode with the speaker output amplifier and in their microphone mode with the microphone input amplifier.

6. The apparatus according to any of claim 2, which comprises a speaker output amplifier, preferred a class D amplifier, to amplify the speaker signal provided to the first speaker or the second speaker in their speaker mode and that comprises
a microphone input amplifier to amplify the speaker microphone signal provided by the first speaker or the second speaker in their microphone mode and that comprises
a shunt resistor arranged between the output of the speaker output amplifier and the speaker contact of the first speaker or the second speaker wherein the control circuit is arranged to switch the impedance value of the shunt resistor to about zero in the speaker mode and to about the speaker impedance of the speaker up to 10 k Ohm in the microphone mode of the first speaker or second speaker.

7. The apparatus according to any of the claim 1, which comprises
a speaker output amplifier, preferred a class D amplifier, to amplify the speaker signal provided to the first speaker or the second speaker in their speaker mode and that comprises
a microphone input amplifier to amplify the speaker microphone signal provided by the first speaker or the second speaker in their microphone mode and that comprises
a shunt resistor arranged between ground and the input of the microphone input amplifier, wherein the control circuit is arranged to adjust the impedance value of the shunt resistor in order to modify the frequency response of the microphone signal gained from the first speaker or the second speaker.

8. The apparatus according to any of the preceding claims, which signal processor is built to process the second microphone signal from the first speaker for substitution of the first microphone signal with minimal distortion while switching between the first and the second microphone signal.

9. The apparatus according to claim 7, wherein the signal processor is built to cross fade while switching between the first and the second microphone signal.

10. The apparatus according to claim 2, wherein the first speaker is a speaker built to be used close by a human ear and wherein the second speaker is a speaker used for a hands-free modus of the apparatus.

11. The apparatus according to claim 2, which apparatus is realized as a mobile phone and comprises communication means to communicate voice and data signals in an uplink and a downlink channel.
